(19) United States
(12) Patent Application Publication
(10) Pub. No.: US 2009/0250936 A1
(43) Pub. Date: Oct. 8, 2009

(54) System and Method for Efficiently Harnessing and Converting Aircraft Exhaust to Electrical Power

(76) Inventor: Tarek O. Souryal, Dallas, TX (US)

Correspondence Address: BAKER BOTTS L.L.P., 2001 ROSS AVENUE, SUITE 600, DALLAS, TX, 75201-2980, US

(21) Appl. No.: 12/062,921

(22) Filed: Apr. 4, 2008

(51) Int. Cl. F03D 9/00; F03D 9/02

(52) U.S. Cl. 290/55; 290/4 R

(57) ABSTRACT

A system for converting aircraft exhaust to electrical energy is provided. In one example the system includes a plurality of mobile, modular, configurable turbine units. The units may be arranged in clusters, which may have any of a number of configurations depending on, for instance, the terrain where the cluster is to be installed. In one example, a cluster of units has at least one row having a plurality of units and the cluster is positioned at the takeoff end of a runway to receive an airflow created by jet exhaust and prevailing winds. The individual turbine units operated one or more generators to produce electricity which may be transmitted to storage devices, power grids, or power drains such as houses, airport facilities, or electronic devices.

### TECHNICAL FIELD

This invention relates general to conversion of wind to electricity and, more particularly, to systems and methods for converting wind created by aircraft exhaust into electrical power.

### BACKGROUND

The cost of oil and certain other energy resources continues to rise. There is also much concern regarding the environmental impact of the use of certain forms of energy. These are among the many factors that have led to an increased focus on the development of cheaper, cleaner, alternative forms of energy.

One alternative energy form is wind, or more specifically the conversion of wind to electric power. Windmills, or wind turbines may be used to receive the renewable resource of wind and convert the wind into a useful power supply such as electricity. The electricity can then be delivered to a power grid. A single turbine can be deployed in a certain area. However, a more typical scenario is the creation of a wind farm, or a group of wind turbines, in an area that has relatively strong and steady prevailing winds. The turbines of the wind farm each generate their own power and the power is collectively distributed to a power grid.

Wind turbines generally have one of two configurations. These are known as “vertical axis” or “horizontal axis.” A typical wind turbine used in a wind farm is a very large, fixed structure having three blades and a horizontal axis configuration. While there may be many turbines in a single farm, the turbines themselves are independent.

There has been some attention directed to harnessing wind that is not naturally generated. For example, U.S. Pat. No. 5,998,882 issued to Jerry L. Alston describes an apparatus for capturing the exhaust stream of a jet aircraft. The apparatus described has a retractable, funnel-shaped structure which captures the exhaust and directs it through a duct into an air turbine. The turbine rotates a shaft, which is connected to a generator, which in turn produces electrical power. The duct, turbine, shaft, and generator are all housed in a concrete box which is disposed below ground level. The funnel-shaped structure is retractable into the concrete box so that, in a retracted position, it too is disposed below ground level. The apparatus has a single turbine and is generally a large, fixed structure.

### SUMMARY

The Alston apparatus has several drawbacks. For instance, because it is a large, fixed structure, once it is constructed it should be considered permanent. It may not be moved from one location to another, and it may not be reconfigured. Configurability is also prevented by the fact that the apparatus has a single turbine. Further, because the majority of the components are located below ground, the apparatus is difficult to access and maintain.

An example embodiment of the present invention includes a system for converting an airflow comprising aircraft exhaust into electrical power. The system includes multiple modular turbine units configurable into a cluster. The cluster has at least one row of a plurality of adjacent turbine units and is positionable to receive the airflow. Each of the plurality of turbine units has a rotor. At least one generator is coupled to at least one of the rotors and is operable to convert rotational energy of the plurality of rotors into electric power.

The present invention and its various embodiments provide certain advantages over known wind power devices. Among other things, at least one embodiment includes a plurality of mobile, reconfigurable turbines, which may be placed adjacent to one another and/or coupled together. The turbines may be provided individually or in groups, clusters, pods, etc. Because each of the individual turbine elements is relatively small compared to a single, large, fixed device, they may be strung together to cover a wide area, while collectively keeping a relatively low vertical profile. The individual turbines and the overall apparatus and system may be easily accessed, maintained, and moved if necessary. Thus, certain embodiments of the present invention provide a flexible, adaptable, wind power generation system, that may be easily installed and maintained at, for example, an airport runway. The configurability and mobility of the system also enables the use of the system at other locations in which a typical “wind farm,” or a large, fixed, single device would otherwise be impractical. For instance, the system may be employed on the top of a large building in a downtown area in order to provide supplemental power to the building or to return electrical energy to the local power grid.

Additional features and advantages of the invention will become apparent in the following detailed description and in the drawings and claims. It should be understood that any particular embodiment may have some, none, or all of these advantages.

### BRIEF DESCRIPTION OF THE DRAWINGS

FIG. 1 is plan diagram illustrating an example airport runway and taxiway configuration and the placement of two groups of turbine units according to an example embodiment of the invention;

FIG. 2 is plan view of a group of turbine units according to an example embodiment of the invention;

FIG. 3 is a front elevation of the turbine units shown in FIG. 2;

FIG. 4 is a plan view of a group of turbine units according to an example embodiment of the invention;

FIG. 5 is a front elevation of an alternate configuration of a group of turbine units according to an example embodiment of the invention;

FIG. 6 is an alternative to the embodiment shown in FIG. 5;

FIG. 7 is a front elevation of another alternate configuration of a group of turbine units according to an example embodiment of the invention;

FIG. 8 is a plan view of an alternate configuration of a group of turbine units according to an example embodiment of the invention;

FIG. 9 is a plan view of an alternate configuration of a group of turbine units according to an example embodiment of the invention;

FIG. 10 is an elevation of a group of turbines according to an example embodiment of the present invention;

FIG. 11 is an elevation of a plurality of groups of turbines according to an example embodiment of the present invention;

FIG. 12 is an elevation of a plurality of groups of turbines according to an embodiment of the present invention;

FIG. 13 is a diagram of a turbine according to an example embodiment of the present invention;

FIG. 14 is a plan view of a plurality of turbines according to an example embodiment of the present invention; and

FIG. 15 is a plan view of a plurality of turbines according to an example embodiment of the present invention.

### DETAILED DESCRIPTION

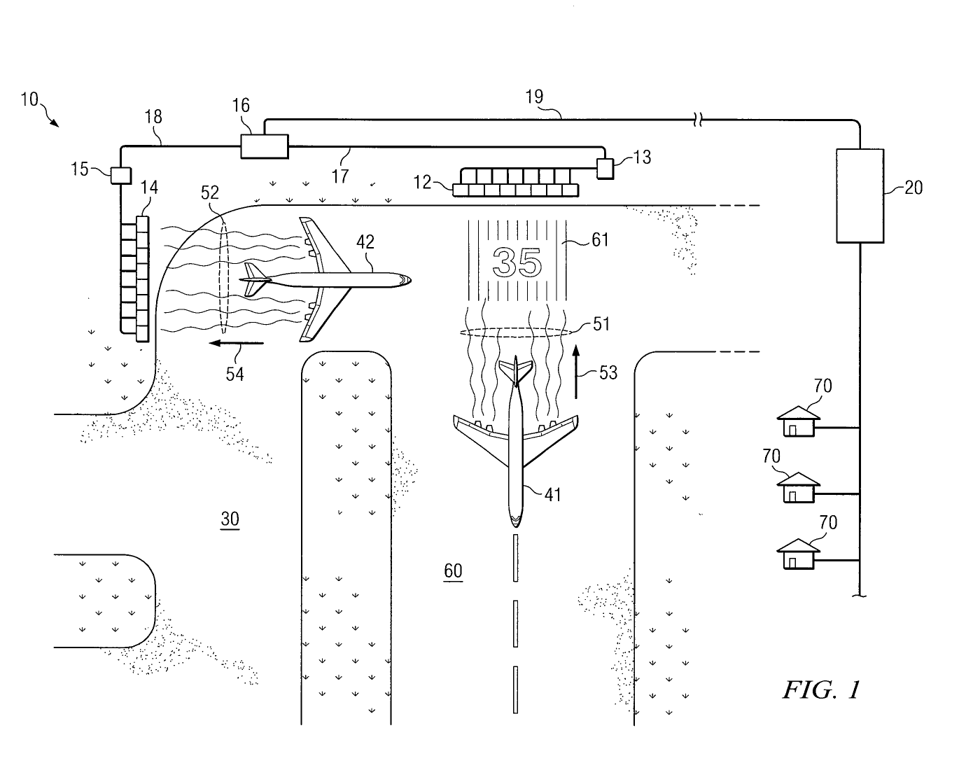

FIG. 1 illustrates a general example layout of a wind power generation system according to an example embodiment of the invention. FIG. 1 illustrates two groups of turbine units strategically placed at two different positions on an airfield. In this example, the groups of turbine units are used to capture the wind created by aircraft exhaust and convert that wind into electric energy. FIG. 1 will be described in greater detail later. It should be understood in this description that although a variety of terms are used such as turbine, rotor, turbine unit, group, cluster, and pod, these terms are not necessarily intended, in all instances, to have a single fixed meaning. At types, the meanings of these terms overlap and at times the terms are used interchangeably.

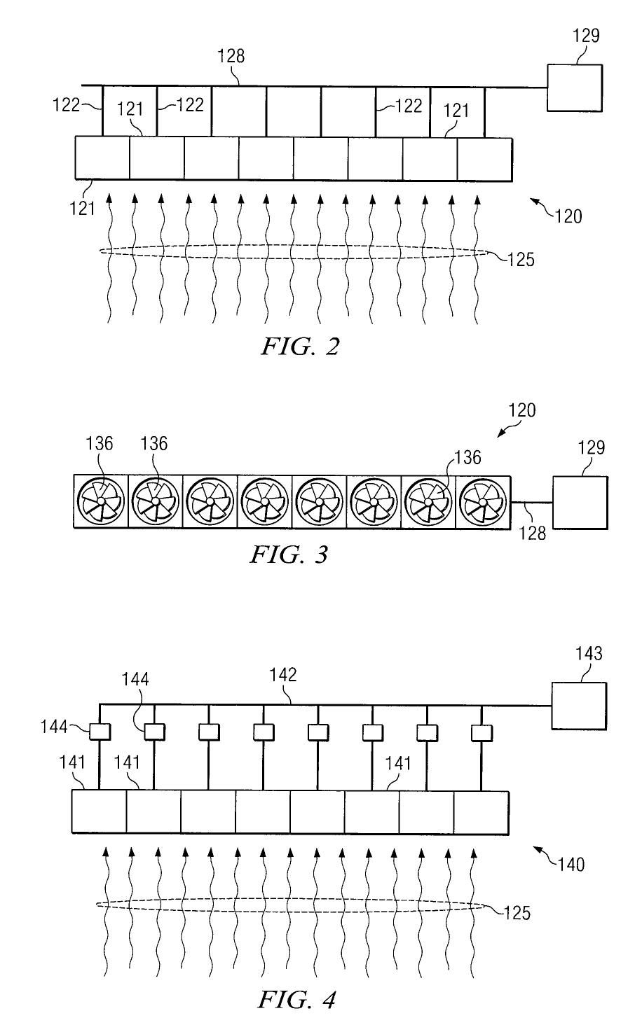

FIG. 2 illustrates an example embodiment of the apparatus for converting wind into electric energy. As shown, there is provided a cluster 120 comprising a plurality of turbine units 121. Turbine units 121 may be provided as individual units, which may be arranged adjacent one another. In one example, the weight of the units keeps the units arranged adjacently. Alternatively, the units may be fixedly coupled together by any suitable coupling mechanism (not expressly shown). This might include, for example having one or more bolts extending outwardly from the side of one unit to fit in a corresponding slot provided on the side of an adjacent unit. Or, the units may be bolted together. Another possible connection mechanism might be a latch or bar overlapping a portion of the front, back, and/or top of two adjacent units. These are examples only, and it will be readily understood that any suitable coupling device or method may be employed to join the units together. As yet another alternative for keeping the units in position, the units may be placed on a base (not expressly shown). In one embodiment, a base is affixed at any, some, or all of the positions, such as the various potential positions on an airfield, where it is anticipated that one or more units might be installed. This might be achieved, for example, by affixing a metal base on a concrete footer. The metal base may be provided with preformed holes, or other appropriate receptacles, for receiving coupling mechanisms to affix the unit(s) to the base. Again, this is an example only, and many possibilities exist for a configuration employing a base. Again, it should be understood that the individual turbines, groups of turbines and/or turbine clusters may be mobile or fixed.

In the embodiment illustrated in FIGS. 2 and 3, for example, there is shown a configuration comprising a single row of turbine units 121. Each unit has a fan, or set of turbine blades, such as the sets 136 shown in FIG. 3. It should be understood that any of a variety of turbine devices may be used to receive wind. In one embodiment, the turbine blades comprise a high-strength plastic capable of withstanding high wind speeds and high rotational speeds. Any suitable material, however, may be used. In one embodiment, the blades are arranged in a pattern of four blades equally spaced around a central hub. It will be understood, however, that this is an example only and a variety of blade formations and configurations are possible.

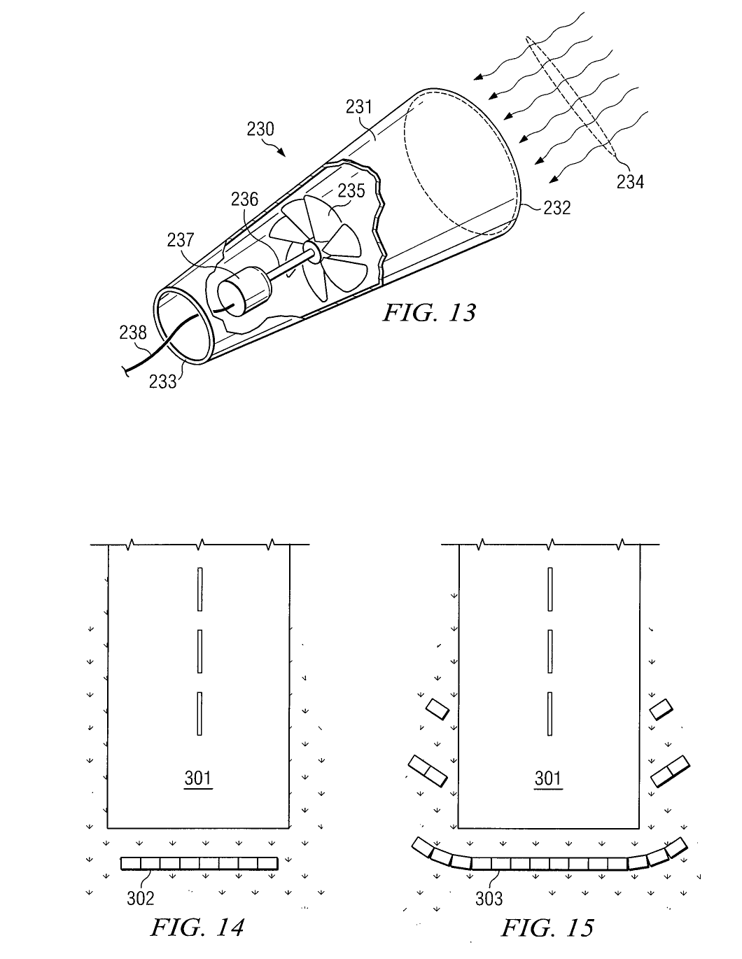

As shown in FIG. 13, a turbine may be configured as a pod 230 having a rotor 235 housed therein. Pod body 231 extends from a first (intake) end 232 to a second (output) end 233. In one example, the pod is tapered so that a cross-sectional area of the pod body decreases from the first end to the second end. Among other things, this produces a nozzle effect for the airflow passing through the pod body. Airflow 234 generated from jet exhausts during takeoff can be as great as 200 mph or more at 150 feet or more from the end of the jet. The funnel effect of the pod body can increase the speed of the airflow impacting the turbine blades, thereby increasing the corresponding amount of electric power being generated by the respective turbine. In the example shown, the pod body also houses shaft 236 and generator 237. Power transfer cable 238 extends from the output end of the body. This is an example configuration only and it should be understood that other types and shapes of pods and pod bodies may be used. Also, the pod body, if used, may house only certain selected parts of the turbine unit.

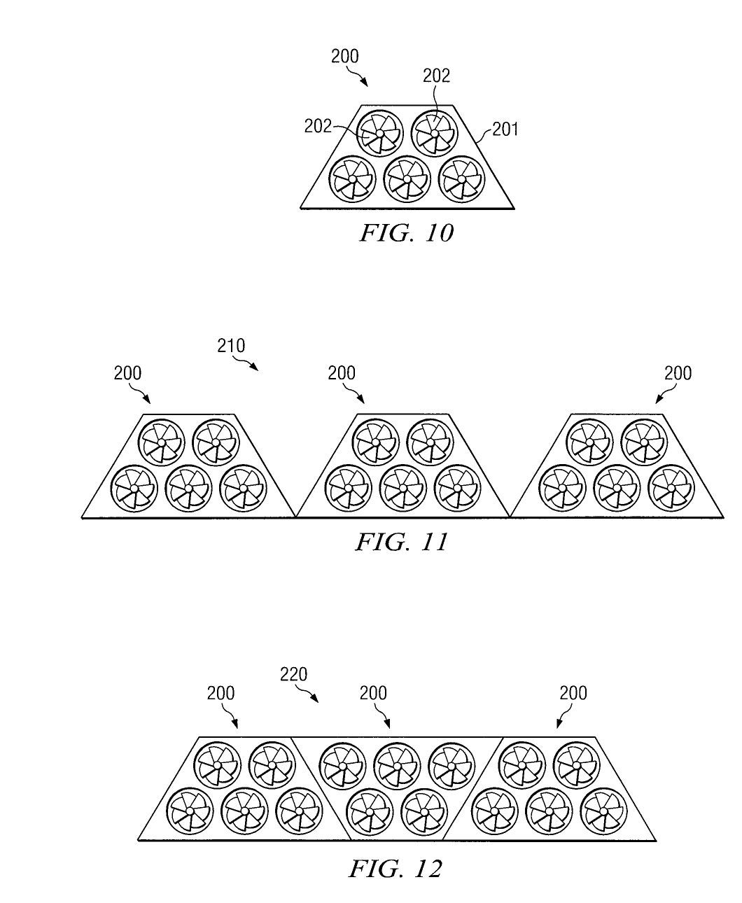

As shown in FIG. 10, in one example configuration, the turbines 202 are arranged in a group 200, supported by a frame 201. As shown, the axes of turbines on an upper row are offset from the axes of the turbines on the lower row. This configuration has the effect of maximizing the amount of wind flow that impacts the turbine blades before passing by the structure. As shown in FIG. 11, the groups 200 may be arranged side-by-side in a cluster 210. According to an alternate configuration, as shown in FIG. 12, the groups are arranged in cluster 220. However, in this example, every other group is inverted.

Furthermore, it should be understood that turbines, pods, groups and/or clusters may also be arranged behind one another or in front of one another with respect to the direction of airflow. Likewise, turbines may be arranged above or below one another with respect to the ground. Any configuration may be used as desired in this regard. In one example, as shown in FIG. 14, a cluster 302 is provided in which each turbine or group of turbines is arranged to be substantially axially aligned with a centerline of a runway 301. Thus, the axes of the turbines are aligned with the flow of exhaust from a jet lined up on the runway as the exhaust exits the engines. In an alternate configuration, as shown in FIG. 15, a cluster 303 is arranged so that some of the turbines are axially aligned with the runway 301. However, other turbines are positioned so that they will be axially aligned with portions of the jet exhaust flow which diverge from parallel with the runway. In other words, as the exhaust, and winds created by the exhaust, travel away from the jet's engines, a certain portion of the flow can be expected to shift to a direction that is no longer parallel with the runway. One or more non-parallel turbines (i.e., toward the outer ends of the cluster) are preferably aligned with these portions of the airflow. Also, additional turbines may be positioned along the edges of the runway, as illustrated, to capture divergent airflow as the jet moves along the runway. In another example (not expressly shown), one or more turbines may be arranged on an exhaust deflector such as those found at the end of certain runways or adjacent to hangars or repair bays. These deflectors may exist, for instance, in situations where the exhaust would otherwise negatively impact an adjacent structure or property. Such deflector structures are used to divert the exhaust upward and away from the ground.

It will also be understood that the units, in at least one embodiment, are modular and may be arranged in any of a variety of configurations. Thus, there may be more than one row or column, and their may be partial rows and/or columns. Further, although an example has been described in which the individual units are modular, it should be understood that, in certain other embodiments, a group of units may be preestablished, or created as a single overall unit, in which the various sets of turbine blades are fixed relative to one another.

As shown in FIG. 2, the cluster 120 receives an airflow 125. As mentioned previously, in an airport environment, the airflow may be created by the exhaust of an aircraft. This might be exhausted output from the engines of a jet airplane. However, the wind might be created by other sources, such as propellers of an aircraft. Also, the airflow might be partially or totally natural. For instance, an airport might have a runway aligned so that planes are normally taking off in the direction of a prevailing wind. Thus, the exhaust (or propeller wind) and the prevailing natural wind at the takeoff end of the runway might combine to create the overall airflow impacting the turbine cluster.

As the airflow 125 impacts the cluster 120, a portion of the airflow impacts one or more of the individual turbine units. Each of the turbine units has an associated turbine shaft 122. As airflow 125 impacts a particular unit, it causes rotation of the turbine blades. This rotation in turn causes rotation of the associated turbine shaft. In the embodiment shown in FIG. 2, each of the individual turbine shafts is coupled to a common drive shaft 128. The connection may be made by the use of, for example, universal coupling joints, which can impart rotation of the individual shafts to the common shaft.

Common shaft 128 is coupled to generator 129. Rotation of common shaft 128 causes generator 129 to convert the mechanical energy of the rotating shaft into electrical power. Any suitable generator may be used and the physics and principles of generator operation are generally known. Power from generator 129 may be transmitted to a storage device (e.g., a battery or set of batteries), to a preexisting power grid, or through an arrangement of additional electrical power components to one or more power drains (e.g., houses in a neighborhood adjacent the airport, or to airport facilities, or to a to the electrical system of a building on which the cluster has been installed. Thus, the power may be stored, or transmitted directly to one or more devices or facilities requiring electric power.

In an alternative embodiment, as illustrated in FIG. 4, a cluster 140 comprises a plurality of turbine units 141. Each individual turbine unit 141 preferably has an associated generator 144. The outputs from the generators 144 may be connected, for electrical power collection, via one or more cables 142 (and/or other suitable power transmission components). The electric power may then be stored in, or used by, a storage device 143 or other electrical component.

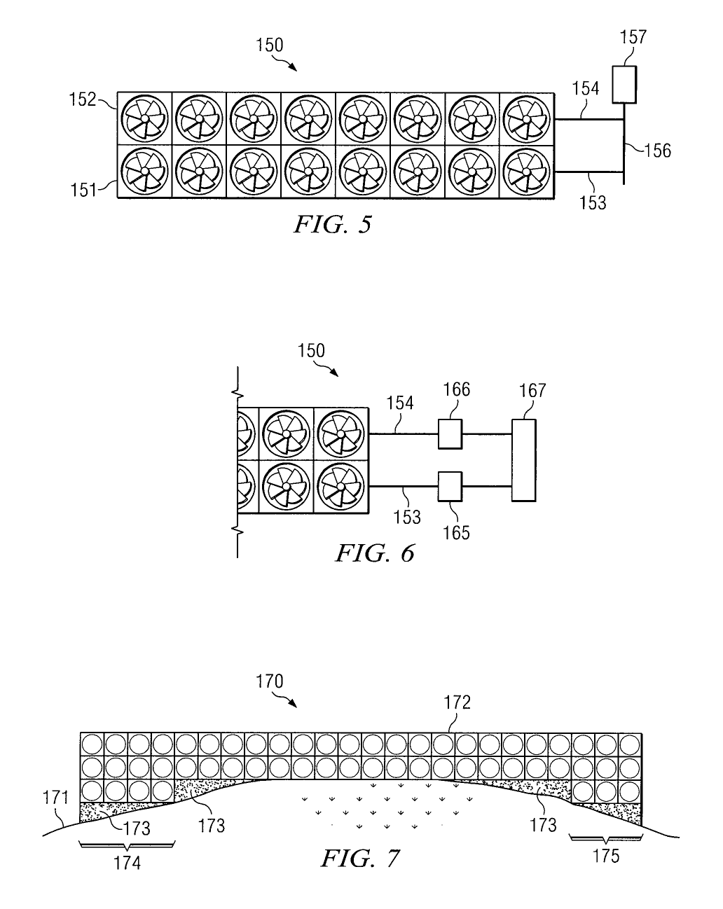

FIGS. 5-7 illustrate other example embodiments in which the units are arranged in something other than a single row. For example, in FIGS. 5 and 6, a cluster 150 includes a first row 151 and a second row 152. First row 151 has a first common shaft 153 associated with the units thereof and second row 152 has a second common shaft 154 associated with the units thereof. In the example shown in FIG. 5, first common shaft 153 is rotated by the rotation of the individual shafts of its associated units and second common shaft 154 is rotated by the rotation of individual shafts of its associated units. First and second common shafts are connected to a third common shaft 136 to cause rotation thereof. Rotation of third common shaft causes generator 157 to generate electric power as already described herein.

In the alternative example shown in FIG. 6. There are separate generators associated with each of first and second common shafts 153 and 154. Thus, first common shaft 153 causes first generator 165 to generate electric power and second common shaft 154 causes second generator 166 to generate electric power. The outputs of first and second generators 165 and 166 are then transmitted to storage device/drain 167. Of course, in each of these configurations, as in other possible configurations, some or all of the individual units may have one or more generators separately associated therewith, so that a given generator is only operated by one shaft, as shown, for example, in FIG. 4.

FIG. 7 illustrates the concept of configuring the mobile, modular units to adapt to the layout or landscape of the installation site. Thus, a runway 171 (for example) might be mounded to provide runoff of precipitation. For most of the width of the runway, it might be desired to have two rows of turbine units. However, as one moves further from the runway centerline, the ground may slope downwardly. Thus, to keep a relatively level configuration of units, it might be desirable to increase the number of rows beginning at certain distances away from the runway centerline. For example, in region 174 of cluster 170, there is provided a third row of four units and in region 175 of cluster 170, there is provided a third row of three units and a fourth row of one unit. There may also be provided filler elements or materials 173 to occupy the empty spaces created by any given configuration. Again, it should be noted that this is an example only. Other configurations might have different numbers of rows and columns (or other configurations) depending on the condition of the terrain, base building, or other installation locale. In another example configuration (not expressly shown) there might be a third dimension to the units of a cluster in which one unit is located entirely, or partially, downwind of another unit. Myriad configurations are possible.

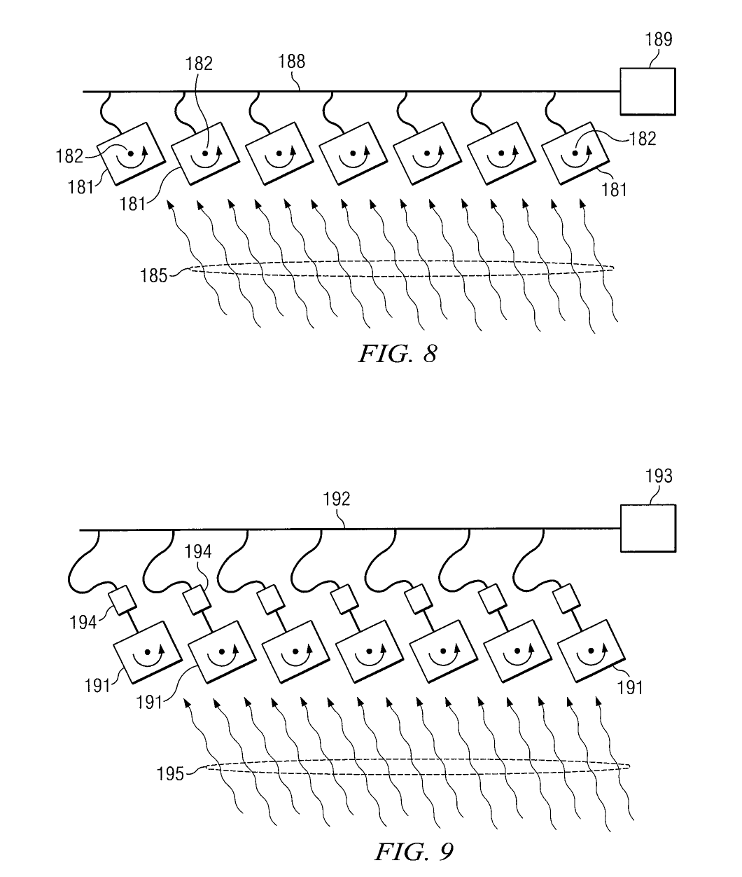

FIGS. 8 and 9 illustrate yet other example embodiments. In these embodiments, the turbines are mounted on a rotatable platform or other device so that the axis of the turbine may be shifted. In FIG. 8, each turbine 181 is rotated the same amount about a point 182. The respective turbine shafts are coupled to the common shaft with a universal-type coupler. In FIG. 9, the turbines 191 are each shown to be rotated the same amount. However, because they are not fixedly coupled to a common shaft, they may be individually rotated different amounts. Depending on the point of rotation, the respective generators 194 are likewise rotated. Power transmission cable 192 should be installed or configured to accept the movement of generators 194 relative to device 193. Rotation of the turbines allows for more efficient harnessing of flows 185 and 195, respectively, which may shift. For instance, in times when a runway is not in use, a prevailing wind might not be aligned exactly with the runway. Thus, rotation of the turbines allows for more direct impact of the prevailing wind.

Other aspects and features may be incorporated into one or more of the various embodiments. For instance, as previously mentioned, one or more clusters may be mounted at various locations, such as various positions on an airfield. For instance, FIG. 1 illustrates a first cluster 12 and a second cluster 14. First cluster 12 may have associated therewith one or more generators 13, or storage devices or other electrical power transmission components. Similarly, second cluster 14 may have associated therewith one or more generators 15, or storage devices or other electrical power transmission components. Power from first cluster 12 may be transmitted via power transmission cable 17 to a substation 16. Power from second cluster 14 may be transmitted via power transmission cable 18 to substation 16. Power may then be transmitted via power transmission cable 19 to power grid 20 and/or to facilities 70, or to other storage devices or electrical transmission devices, transmission components, or other electrical components as desired.

As shown in FIG. 1, first cluster 12 is arranged at the takeoff end 61 of runway 60 “Three-Five.” Thus the wind created by the engine exhaust of jet 41 (together with any prevailing natural wind) creates an airflow 51 in the direction of arrow 53, which impacts the turbine units of cluster 12 to generate electric power as already described. Similarly, second cluster is positioned at the exhaust end of engine run-up area on taxiway 30. Thus, the wind created by the engine exhaust of jet 42 (together with any prevailing natural wind) creates an airflow 52 in the direction of arrow 54, which impacts the turbine units of cluster 14 to generate electric power as already described. It should be noted that the clusters may be arranged at any of a variety of advantageous locations about the airfield in order to harness exhaust, or other natural or man-made airflows. It should also be noted that the system illustrated in FIG. 1 is but one example and the various components may be rearranged and/or coupled with various other components, as desired, to produce electrical power from natural and man-made wind. For example, as previously mentioned, one or more clusters may be mounted on the top of a building (at the airport or a downtown area, for example) to take advantage of other wind sources and other areas of prevailing wind.

The invention has been shown in several embodiments. It should be apparent to those skilled in the art that the invention is not limited to these embodiments, but is capable of being varied and modified without departing from the scope and spirit of the described example embodiments.

What is claimed is:

1. A system for converting an airflow comprising aircraft exhaust into electrical power, the system comprising:
a plurality of modular turbine units configurable into a cluster, the cluster comprising at least one row of a plurality of adjacent turbine units, the cluster positionable to receive the airflow;
each of the plurality of turbine units comprising at least one rotor;
at least one generator coupled to at least one of the rotors and operable to convert rotational energy of the plurality of rotors into electric power.

2. The system of claim 1, wherein each of the plurality of turbine units comprises a shaft and a generator coupled to the shaft, wherein each shaft imparts rotational energy of its associated rotor to its associated generator, and wherein the electric power from each generator is transmitted to a common electrical component.

3. The system of claim 1, further comprising a common shaft, each of the plurality of rotors being mechanically coupled to the common shaft to impart rotation to the common shaft, the common shaft coupled to the at least one generator to operate the at least one generator.

4. The system of claim 1, wherein the plurality of turbine units are coupled together to substantially prevent movement of one turbine unit relative to another turbine unit.

5. The system of claim 1, wherein the plurality of turbine units are arranged in at least two rows and where axes of turbines on one row are laterally offset from axes of turbines on at least one other row.

6. The system of claim 1, wherein at least one turbine unit is housed in a body structure.

7. The system of claim 1, wherein at least one turbine unit is housed in a body structure having a cross-sectional area decreasing from a first end to a second end.

8. The system of claim 1, wherein the electrical component is a storage device.

9. The system of claim 1, wherein the electrical component is a power grid.

10. The system of claim 1, wherein the electrical component is an airport facility.

11. The system of claim 1, wherein the electrical component is a power drain.

12. The system of claim 1, wherein the electrical component is a house.

13. The system of claim 1, wherein the plurality of turbine units are arranged in a row.

14. The system of claim 1, wherein the plurality of turbine units are arranged in at least two rows, one row being positioned vertically above at least one other row.

15. The system of claim 1, wherein the plurality of turbine units are arranged in cluster.

16. The system of claim 15, wherein the cluster comprises at least two groups of turbine units and each group comprises a plurality of turbine units spatially fixed relative to one another.

17. The system of claim 1, wherein the plurality of turbine units comprises a first group of turbine units positioned at a first position on an airfield and a second group of turbine units positioned at a second position on the airfield remote from the first position.

18. The system of claim 17, wherein at least one turbine unit is positioned at a runway end and at least one turbine unit is positioned at a run-up area.

19. The system of claim 1, wherein at least one of the plurality of turbine units has an airflow axis that is non-parallel compared to an airflow axis of at least one other of the plurality of turbine units.

20. The system of claim 1, wherein at least one turbine unit is mounted on a base.

21. The system of claim 1, wherein at least one turbine unit is rotatable about an axis that is not coaxially with its airflow axis.
